(19) United States
(12) Patent Application Publication
(10) Pub. No.: US 2026/0080242 A1
(43) Pub. Date: Mar. 19, 2026

(54) HARDWARE DESCRIPTION LANGUAGE CODE GENERATION WITH FINE-TUNED LARGE LANGUAGE MODELS

(71) Applicant: NVIDIA Corporation, Santa Clara, CA (US)

(72) Inventors: Mingjie Liu, Cedar Park, TX (US); Yun-Da Tsai, New Taipei (TW); Wenfei Zhou, Los Angeles, CA (US); Haoxing Ren, Austin, TX (US)

(21) Appl. No.: 19/072,609

(22) Filed: Mar. 6, 2025

Related U.S. Application Data
(60) Provisional application No. 63/695,351, filed on Sep. 16, 2024.

(51) Int. Cl. G06N 3/08; G06F 8/35

(52) U.S. Cl. CPC G06N 3/08; G06F 8/35

(57) ABSTRACT

Embodiments of the present disclosure provide systems and methods for fine-tuning a pretrained large language model (LLM) for generating hardware description language (HDL) code. In at least one embodiment, a first training dataset that includes correct-by-construction non-textual representation data samples is obtained, and the pretrained LLM is fine-tuned using the first training dataset to provide the fine-tuned LLM for generating HDL code.

### CLAIM OF PRIORITY

This application claims the benefit of U.S. Provisional Application No 63/695,351, titled “High-quality Synthetic Data Generation for Verilog Code Models with Correct-by-Construction Non-Textual Representations and Targeted Code Repair” and filed Sep. 16, 2024, the entire contents of which are incorporated herein by reference.

### BACKGROUND

Recently, significant progress has been made in training large language models (LLMs) to perform coding tasks. While most code-generating LLMs concentrate on software programming languages, there is increasing interest in developing models for hardware description languages (HDLs), which are used for chip design and hardware verification. However, training LLMs to generate HDL code (e.g., Verilog code), is challenging due to the relative scarcity of training data. As a result, the ability of LLMs to effectively learn diverse and complex coding patterns associated with HDLs is restricted. Additionally, verifying the correctness of HDL code that is generated using an LLM is inherently more complex than verifying software code.

### SUMMARY

Embodiments of the present disclosure provide systems and methods for fine-tuning a pretrained large language model (LLM) for generating hardware description language (HDL) code. In at least one embodiment, a first training dataset that includes correct-by-construction non-textual representation data samples is obtained, and a pretrained LLM is fine-tuned using the first training dataset to provide a fine-tuned LLM for generating HDL code.

### BRIEF DESCRIPTION OF THE DRAWINGS

The present systems and methods related to high-quality hardware description language (HDL) code generation with fine-tuned large language models (LLMs) are described in detail below with reference to the attached drawing figures, wherein:

FIG. 1A illustrates a flowchart of a method for using non-textual representations to improve HDL code generation, in accordance with an embodiment;

FIG. 1B illustrates a flowchart of a method for using targeted code repair to generate synthetic training data to improve HDL code generation, in accordance with an embodiment;

FIG. 1C illustrates a flowchart of a method for fine-tuning a pretrained LLM using synthetic training data, in accordance with an embodiment;

FIG. 2 illustrates a block diagram of an example system suitable for use in implementing one or more embodiments of the present disclosure;

FIG. 3A illustrates correct-by-construction training data for improving HDL code generation, in accordance with an embodiment;

FIG. 3B illustrates correct-by-construction training data for improving HDL code generation, in accordance with an embodiment;

FIG. 3C illustrates waveform creation and testing for generating synthetic training data for improving HDL code generation, in accordance with an embodiment;

FIG. 3D illustrates targeted code repair data used as training data for improving HDL code generation, in accordance with an embodiment;

FIG. 3E is a table comparing HDL code generation performance of an LLM fine-tuned with synthetic training data, in accordance with an embodiment, to that of alternative LLMs;

FIG. 4 is a conceptual diagram of a processing system implemented using a PPU, suitable for use in implementing some embodiments of the present disclosure;

FIG. 5A illustrates an exemplary system in which the various architecture and/or functionality of the various previous embodiments may be implemented;

FIG. 5B illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

The present disclosure provides systems and methods for improving hardware description language (HDL) code generation with large language models (LLMs). The effectiveness of performing code generation using LLMs is, irrespective of the particular language, largely influenced by the size and quality of training datasets available for training the LLMs to generate code. HDLs (e.g., Verilog) are considered low resource languages because the amount of available training data is scarce when compared to the amount of available training data for high-resource software programming languages (e.g., Python). The limited availability of training data limits the ability of the LLMs to effectively learn diverse and complex coding patterns related to HDLs.

Conventional code generating LLMs often lack the capability to effectively understand and process non-textual representations—which are commonly used in HDLs. Furthermore, conventional code generating LLMs are typically unable to generate satisfactory testbenches for assessing HDL code quality, as it is inherently more complex to verify the correctness of HDL code than the correctness of software code.

According to a first aspect, the present disclosure provides systems and methods for generating, using a fine-tuned LLM, HDL code. The fine-tuned LLM is produced by fine-tuning a pretrained LLM using synthetic training data generated for non-textual representations (e.g., Karnaugh Maps (KMaps), truth tables, finite state machines (FSMs) and waveforms). In one or more embodiments, the synthetic training data is generated by sampling a plurality of random configurations of non-textual representations, generating a set of problems associated with the sampled random configurations, and generating HDL code for the set of problems associated with the sampled random configurations. In at least one embodiment, the synthetic training data additionally includes training data for waveform problems. By fine-tuning the pretrained LLM, the ability to handle non-textual representations is significantly enhanced. According to a second aspect, the present disclosure provides systems and methods for fine-tuning a pretrained LLM, using synthetic training data, to transform the pretrained LLM into a fine-tuned LLM configured to generate HDL code. According to a third aspect, the present disclosure provides systems and methods for generating a training dataset including synthetic training data suitable for fine-tuning a pretrained LLM.

According to one or more embodiments, a method is provided for fine-tuning a pretrained large language model (LLM) to provide a fine-tuned LLM for generating hardware description language (HDL) code. The method includes obtaining the pretrained LLM and obtaining a first training dataset. The first training dataset includes correct-by-construction non-textual representation data samples. The method further includes fine-tuning, using the first training dataset, the pretrained LLM to provide the fine-tuned LLM for generating HDL code.

According to an embodiment of the method, obtaining the first training dataset includes sampling a plurality of random configurations associated with a non-textual representation of data, generating a plurality of problems associated with the non-textual representation of data based on the sampled plurality of random configurations, and generating hardware description language (HDL) source code for the non-textual representation of data by solving the plurality of problems of the non-textual representation of data.

According to an embodiment of the method, the non-textual representation is a truth table, and sampling the plurality of random configurations includes randomly selecting a number of input variables from a set of possible numbers of input variables for generating the truth table. According to a further embodiment, the non-textual representation is a finite state machine, and sampling the plurality of random configurations includes randomly selecting a number of states, an input bit width, and an output bit width. According to a further embodiment, generating the plurality of problems includes generating a legal state transition graph based on the selected number of states. According to a further embodiment, the method includes generating a plurality of testbenches associated with the HDL source code, simulating the HDL source code along with the plurality of testbenches using an HDL simulator to generate an output file, and constructing a waveform problem based on the output file.

According to an embodiment of the method, generating the plurality of problems associated with the non-textual representation of data includes generating minterms and don't-care terms based on the selected number of input variables.

According to an embodiment of the method, solving the plurality of problems of the non-textual representation of data includes generating at least one of a truth table and a Karnaugh map associated with the plurality of problems.

According to an embodiment, the method further includes obtaining a second training dataset including targeted code repair data samples and fine-tuning, using the second training dataset, the pretrained LLM to provide the fine-tuned LLM for generating HDL code. According to a further embodiment, obtaining the second training dataset includes correcting an error detected in a portion of hardware description language (HDL) source code generated by the LLM, generating a detailed error report based on the correction performed in the portion of HDL code, determining whether the generated detailed error report is consistent, and injecting a portion of open-source HDL source code with the detected error based on determining that the generated detailed error report is consistent. According to a further embodiment, determining whether the generated detailed error report is consistent includes determining whether the generated detailed error report fixes the error detected in the portion of the HDL source code, and determining that the generated detail report is self-consistent based on determining that the generated detailed error report fixes the error detected in the portion of the HDL source code. According to a further embodiment, the method further includes performing a self-verification of the second training dataset by determining whether the second training dataset solves the error injected in the portion of open-source HDL source code. According to a further embodiment, the second training dataset is discarded based on determining that the second training dataset does not solve the error injected in the portion of open-source HDL source code, discarding the second training dataset.

According to an embodiment of the method, fine-tuning the pretrained LLM to provide the fine-tuned LLM for generating HDL code further includes (a) selecting, using the pretrained LLM, a problem from the first training dataset, (b) predicting, using the pretrained LLM, a solution to the problem selected from the first training dataset, (c) comparing the predicted solution with an actual solution to the problem stored in the first training dataset, (d) determining a model loss associated with the fine-tuned LLM based on the comparing, and (e) updating parameters of the pretrained LLM based on the determined model loss. According to an embodiment, the method further includes determining whether the fine-tuning of the pretrained LLM is complete and based on determining that the fine-tuning of the pretrained LLM is not complete, repeating steps a)-e).

According to one or more embodiments, non-transitory computer-readable media is provided having stored thereon executable instructions that, when executed by processing circuitry, cause the processing circuitry to perform the method for fine-tuning a pretrained large language model (LLM) to provide a fine-tuned LLM for generating hardware description language (HDL) code and any embodiment thereof.

According to one or more embodiments, a system for fine-tuning a pretrained large language model (LLM) to provide a fine-tuned LLM for generating hardware description language (HDL) code includes processing circuitry configured to obtain the pretrained LLM and obtain a first training dataset. The first training dataset includes correct-by-construction non-textual representation data samples. The processing circuitry is further configured to fine-tune, using the first training dataset, the pretrained LLM to provide the fine-tuned LLM for generating HDL code.

According to an embodiment of the system, the processing circuitry is configured to obtain the first training dataset by sampling a plurality of random configurations associated with a non-textual representation of data, generating a plurality of problems of the non-textual representation of data based on the sampled plurality of random configurations, and generating hardware description language (HDL) source code for the non-textual representation of data by solving the plurality of problems of the non-textual representation of data. According to an embodiment, the non-textual representation is a truth table, and sampling the plurality of random configurations includes randomly selecting a number of input variables from a set of possible number of input variables for generating the truth table. According to an embodiment, generating the plurality of problems associated with the non-textual representation of data includes generating minterms and don't-care terms based on the selected number of input variables.

According to an embodiment of the system, the processing circuitry is further configured to obtain a second training dataset including targeted code repair data samples and fine-tuning, using the second training dataset, the pretrained LLM to provide the fine-tuned LLM for generating HDL code. According to an embodiment, obtaining the second training dataset includes correcting an error detected in a portion of hardware description language (HDL) source code generated by the LLM, generating a detailed error report based on the correction performed in the portion of HDL code, determining whether the generated detailed error report is consistent, and injecting a portion of open-source HDL source code with the detected error based on determining that the generated detailed error report is consistent.

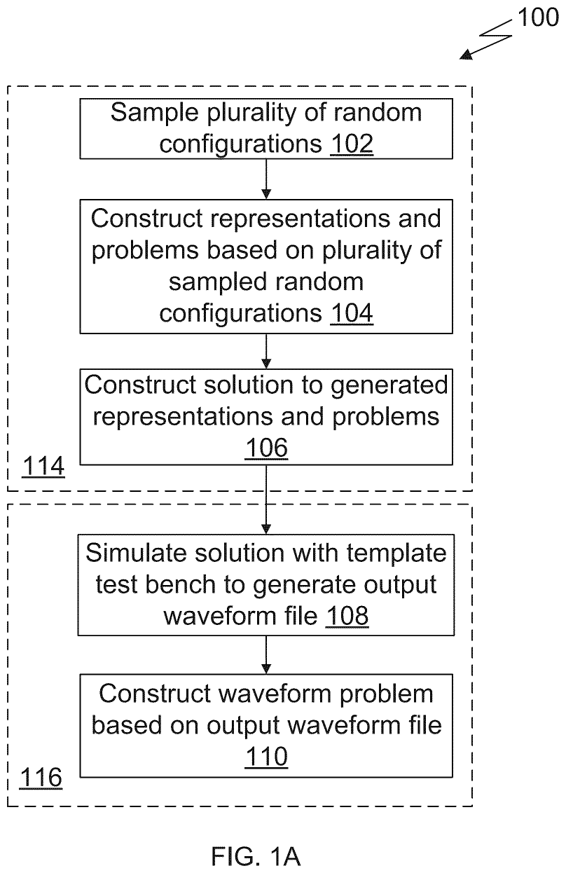

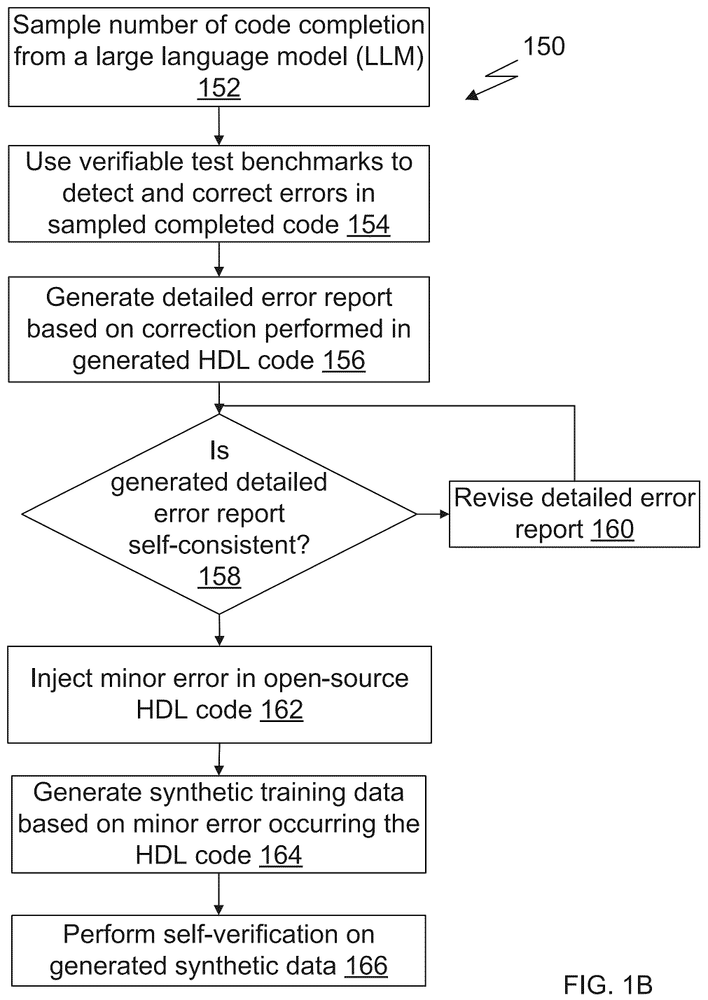

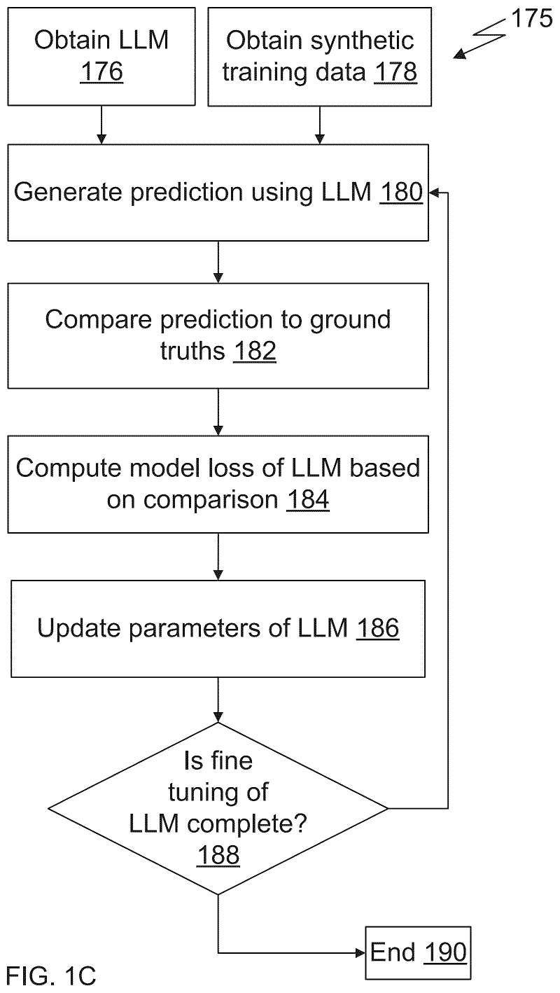

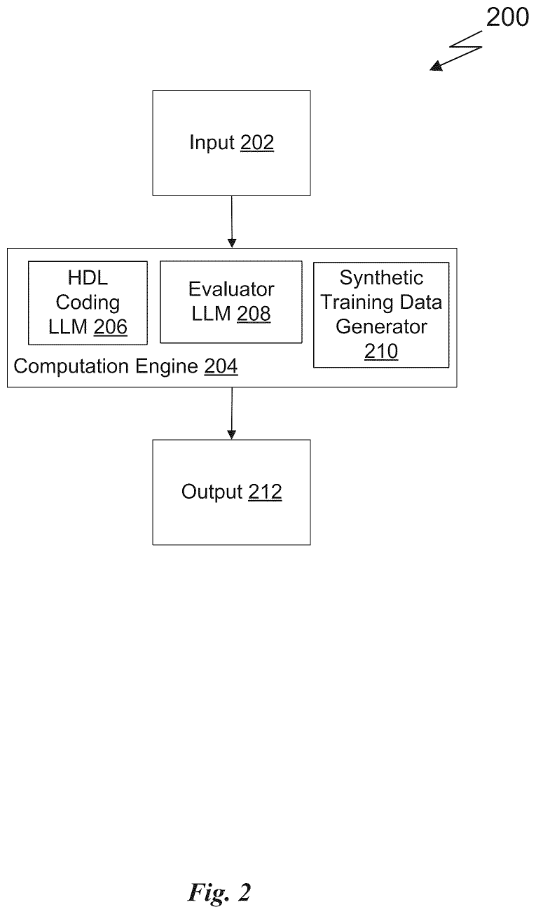

FIG. 1A illustrates a flowchart of a process 100 for generating training data, including correct-by-construction non-textual representations and waveform representations, suitable for use in fine-tuning a pretrained LLM to generate HDL code, in accordance with an embodiment. Each block of process 100, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, process 100 is described, by way of example, with respect to the system of FIG. 2. However, this method may additionally or alternatively be executed by any one system, or any combination of systems, including, but not limited to, those described herein. Furthermore, persons of ordinary skill in the art will understand that any system that performs process 100 is within the scope and spirit of embodiments of the present disclosure.

Process 100 includes a correct-by-construction non-textual representation construction phase 114 and a waveform creation and testing phase 116. In accordance with some embodiments, the correct-by-construction non-textual representations constructed at phase 114 include truth tables, Karnaugh Maps (KMaps), and finite state machines (FSMs). The training data created by process 100 at phase 114 includes pairs of correct-by-construction code problems and solutions based on non-textual representations such as truth tables, KMaps, and FSMs. Additionally, and/or alternatively, the waveform creation and testing phase 116 can use the correct-by-construction code problems and solutions created for truth tables, KMaps, and FSMs to produce waveform value change dump (VCD) files, which are then parsed and converted into wave form representations. The waveform representations are then used to generate training data for another non-textual representation of data, i.e., waveforms.

At 102, phase 114 of process 100 samples a plurality of random configurations related to the non-textual representations or waveforms. In at least one embodiment, sampling the random configuration includes selecting a number of variables and names that are to be used. In at least one embodiment, when sampling a plurality of random configurations for creating KMaps and truth tables, process 100 selects a number of variables and names from a predefined set of variables and names. For instance, the predefined set of numbers can be defined as {3, 4}. In such cases, the number of variables selected for creating problems and solutions using KMaps and Truth Tables can be either three (3) or four (4). If the number of variables selected for creating problems and solutions are three (3), some exemplary ways for naming the three variables can be {a, b, c}, {x, y, z}, {x[0], x[1], x[2]}, {x[1], x[2], x[3]}. The naming of variables can also be based on a predefined convention.

In at least one embodiment, when sampling a plurality of random configurations for state transition graphs and tables, the process 100 selects a number of states n (e.g., 4, 6, or 10), a bit width w of the input signal and a bit width of the output signal.

In some embodiments, the sampling of the plurality of random configurations includes a predefined set of possibilities determined by a user. Users are free to define the predefined set of possibilities so long as it is reasonable (for example, number of states too large would not be reasonable). This allows the users to define the training data for the LLM based on the needs of the user.

At 104, phase 114 of process 100 constructs non-textual representations of training data such as K-Maps, truth tables, and FSMs, and problems associated with the non-textual representations, based on the plurality of sampled random configurations.

In at least one embodiment, constructing representation and problems based on the sampled configurations includes assigning possible values to each of the variables, states, or inputs that are sampled. For example, once the number of variables and names are sampled for KMaps and Truth tables, valid minterms and don't-care terms are assigned to various combinations of the sampled number of variables. In some embodiments, a minterm is a product term in a Boolean expression where a Boolean function, created using the sampled number of variables is true (1) for a specific combination of input values assigned to the sampled number of variables. Each minterm represents a cell in a Truth Table where the output of the Boolean function created using the sampled number of variables is true (1). In such embodiments, a don't-care term is a term where the output of the Boolean function created using the sampled number of variables is not relevant. In such cases, the output can be assigned a value of 0 or 1, whichever value is more convenient to simplify the Boolean function. As part of constructing representations and problems based on the plurality of sampled number variables, process 100 generates a truth table and/or a KMap based on the valid minterms and don't-care terms that are assigned to various combinations of the sampled number of variables. For example, the total number of states for a truth table is 2ⁿ, where n is the number of variables. For example, for three sampled variables (as described above), there are a total of 2³ or eight (8) states (0, 1, 2, 3, 4, 5, 6, 7). From all 8 states minterms and don't cares are selected randomly. In at least one embodiment, the minterms are {0,1} and don't care could be {x}. Based on the above selection, a problem and solution can be constructed.

In at least one embodiment, when the number of states and the bit width of the input is selected for FSMs, the process 100 utilizes an algorithm to create a transition graph that is meaningful and legally defined. In at least one embodiment, the state transition graph can be generated for Moore or Mealy state machines. For example, when generating a transition graph for Moore machines, process 100 initializes the number of states and the bit width of the input. Upon initialization, process 100 randomly generates a tree with a number of nodes that is the same as the number of states that are initialized. The root of the tree is assigned as a reset state. The construction of the tree ensures the reachability of each state. For each node of the tree, process 100 assigns a unique state and an output. Subsequently, process 100 assigns additional transitional edges to each node of the tree, to ensure that each node has an out-degree of 2^{bit width}. By ensuring that each node has an out-degree of 2^{bit width}, a legality of the FSM is ensured. In at least one embodiment, the algorithm can be modified by assigning the output to the edges, instead of the nodes, to generate a transition graph for a Mealy state machine instead of a Moore state machine.

At 106, phase 114 of process 100 constructs a solution to the generated representations and problems. In some embodiments, constructing the solution to the generated representations and problems includes converting the representations and problems generated at 104 to HDL code. In at least one embodiment, the representations and problems generated at 104 are converted to HDL code using a template-based algorithm. For example, once the minterms and don't-care terms are assigned to combinations of the sampled variables, process 100 can generate HDL code in an HDL language of choice (e.g., Verilog), that generates a Boolean function based on the minterms and don't-care terms. For instance, in case the sampled variables are named x, y, and z and the minterm assigned to the sampled variables 3′b001, the Boolean function generated based on the minterm and the sampled variables is ˜x&˜y&z. The Boolean function is used as output logic to generate the HDL code in the HDL language of choice. Pairs of truth tables and/or KMaps and corresponding HDL code can be used together as training data for fine-tuning a pretrained LLM to correctly process non-textual inputs, e.g., truth tables and KMaps, to generate accurate HDL code.

In at least one embodiment, once the state transition graph for the Moore or Mealy state machine is generated, process 100 generates, at 106, HDL code associated with the FSM described in the state transition graph generated at 104. In at least one embodiment, process 100 employs an out-edge focused strategy for state transitions to generate HDL code related to the state transition graph generated at 104. In at least one embodiment, an additional in-edge focused transition logic can be used to address specific challenges related to converting the state transition graphs to HDL code. In at least one embodiment, the specific challenges are present in benchmark problems which often involve states represented using one-hot encoding and require rigorous testing of non-default states. For example, academic benchmark test problems common for benchmarking large language model (LLM) can be used to address specific challenges in FSMs. For instance, a one-hot state encoding of A=4′b0001, B=4′b0010, C=4′b=0100, and D=4′b1000 can be used to derive state transition and output logic equations. In such a state transition diagram, the input states can be one of the four (4) states mentioned above. However, in some cases, outputs are assigned to undefined input states, e.g., 0011. The out-edge strategy assigns an unknown output “x” to such input states, while the in-edge strategy would assign some value of 0 or 1 to the output of such states. The tests in the benchmark problems can also conduct tests on these undefined input states in the out-edge case, and the in-edge strategy could correctly handle such tests in benchmark problems.

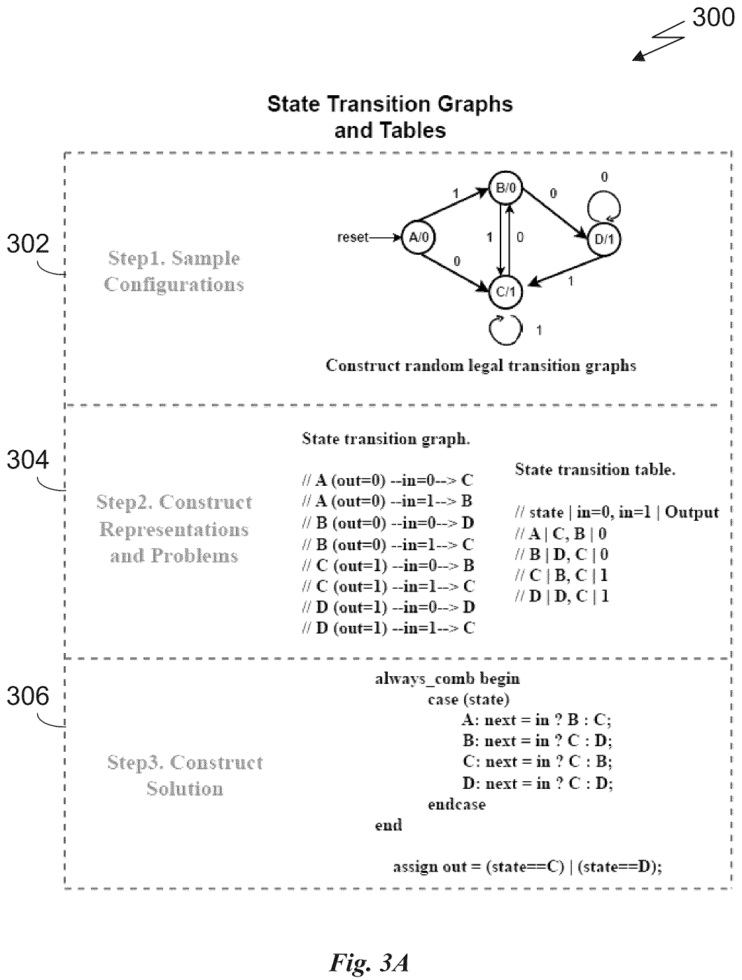

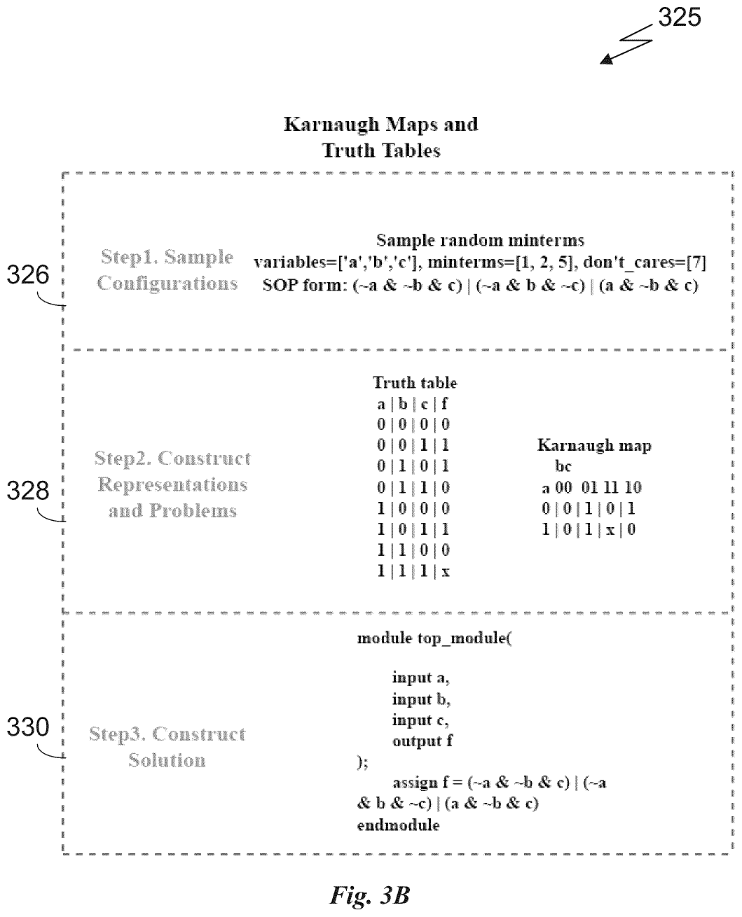

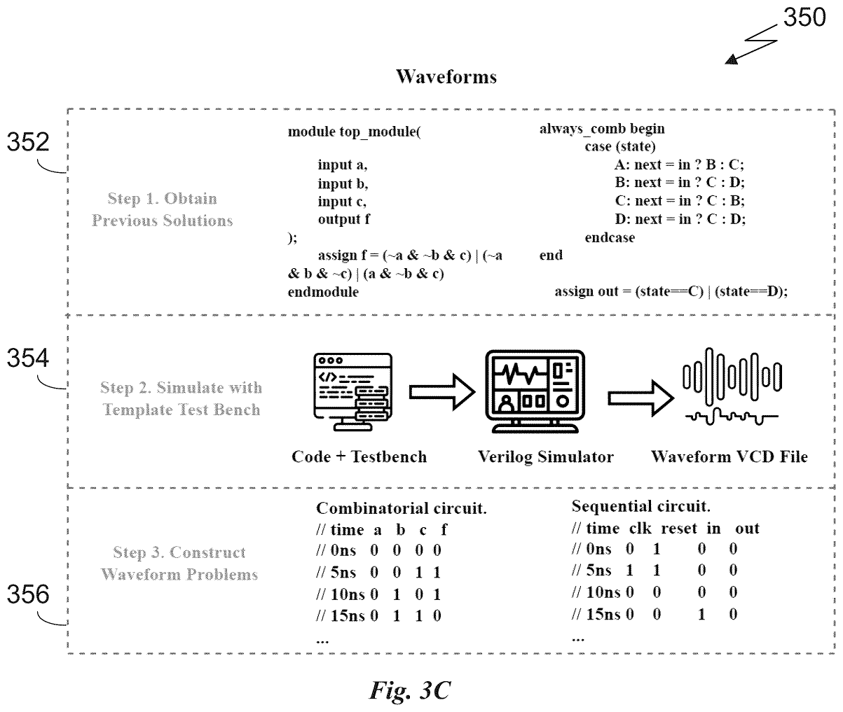

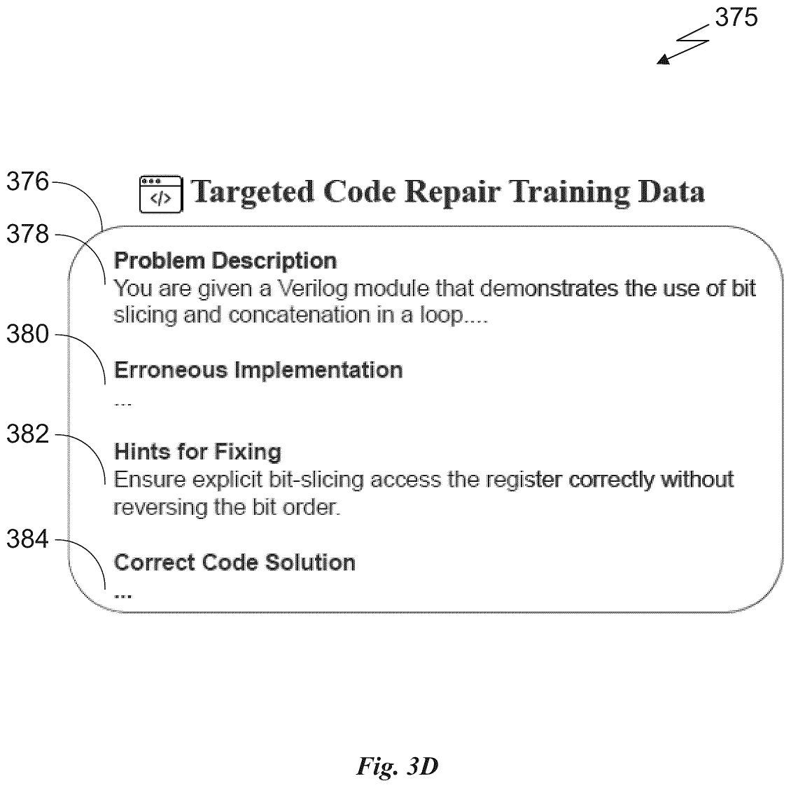

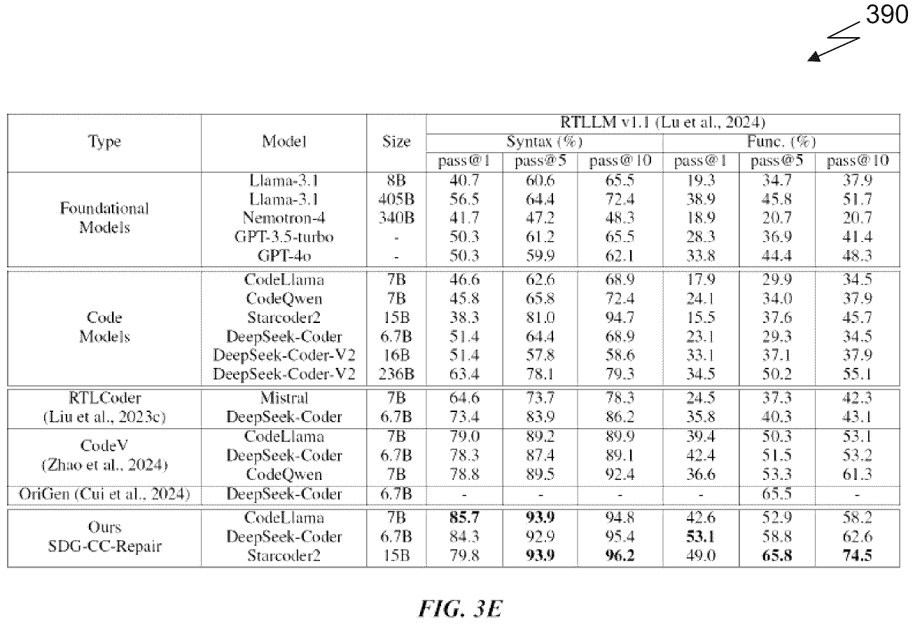

FIGS. 3A-3B illustrate training data for improving HDL code generation. FIG. 3A illustrates a state transition graph, in accordance with an embodiment. 302 provides a sample configuration for a state transition graph, 304 provides a legally defined state transition graph and state transition table, and 306 provides correct-by-construction HDL code associated with the FSM described in the state transition graph of 304. FIG. 3B illustrates a KMap or truth table for improving HDL code generation, in accordance with an embodiment. 326 provides a plurality of random sample configurations, 328 provides representations and problems, based on the sample configurations, in the form of KMaps and Truth tables, and 330 provides a correct-by-construction HDL code solution to the constructed representation and problem. Pairs of truth tables and/or KMaps and corresponding HDL code, as shown in FIG. 3B, can be used together as training data for fine-tuning a pretrained LLM to correctly process non-textual inputs.

Once solutions to generated representations and problems are constructed at 114, process 100 moves to the waveform creation and testing phase 116. At 108, the waveform creation and testing phase 116 of the process 100 simulates the solution constructed at 106 with a template test bench to generate an output waveform file. In at least one embodiment, a set of test benches can be designed for testing the HDL code generated at 106. In at least one embodiment, the test benches are used by an HDL code simulator (e.g., Icarus Verilog), to obtain, for certain inputs, outputs of the HDL code generated at 106. The outputs of the generated code are used to generate training data for waveform problems. In at least one embodiment, the test benches for each type of data are manually generated. For example, a test bench is manually generated for all KMap problems with three (3) variables, and another test bench is manually generated with four (4) variables. This is possible since the generated HDL code related to the KMap problems is based on an algorithm and shares similar structure, which allows test benches to be re-used. In at least one embodiment, the test benches are generated by an LLM.

In at least one embodiment, the test benches can be generated using an LLM. For example, a text prompt can be provided to the LLM to initiate generation of a test bench. The text prompt can be “Write a testbench for the following verilog module: {verilog_module_code}.” In an additional embodiment, the text prompt can also include an example test bench as a reference. For example, the text prompt can be phrased as: “Here is an example of writing a testbench for the following verilog module: {example_verlog_module_code}\n{example_tesetbench_code}. Now write a testbench for the following verilog module: {verilog_module_code}.” Using any of the above provided prompts, the LLM can generate test benches as needed.

The generated test benches include various sets of input values for the sampled number of variables that are used to generate the representations and problems at 104. For example, if the number of variables sampled at 104 includes three variables (e.g., a, b, and c), the set of inputs in the test bench can include various combinations of binary values for each of the three variables. For example, the set of inputs in the test bench can include 000, 001, 010, 011, 100, 101, 110, and 111. In total, the test bench can include up to 2^{input bit width (w)}, e.g., eight (8), sets of input values for the Boolean function. The results of the Boolean function for the various sets of input values in the test bench can be used to create a truth table and/or KMap. Alternatively, if code generation for a state transition graph constructed at 106 includes three (3) states and a two (2) bit wide input, the set of inputs in the test bench generated can include various sets of input values for the sampled input states and two-bit wide input. The results of the FSM for the various sets of input states and two-bit wide input can be used to generate the state transition graph. The truth table and/or KMap or the state transition graph can be used to produce waveform value change dump (VCD) files.

In at least one embodiment, an HDL simulator executes the generated HDL code with the created testbenches to generate the output. The output of the various test benches is used to generate the waveform VCD files, which is a standard output format for HDL simulators.

At 110, process 100 constructs a waveform problem based on the waveform VCD files. For example, a computer program can be used to parse the waveform VCD files to print waveforms in text format. The printed waveforms in text format can be then used to construct a waveform problem. The training data produced by process 100 is suitable for use in fine-tuning a pretrained LLM to generate HDL code, providing a code-generating LLM capable of more accurately and efficiently processing non-textual representations of data when generating HDL source code. A process for using the training data (produced by process 100) for fine-tuning a pre-trained LLM to generate HDL code, in accordance with an embodiment, is described in the context of FIG. 1C below.

FIG. 3C illustrates waveform synthetic training data for improving HDL code generation, in accordance with an embodiment. 352 provides HDL code associated with the FSM depicted in FIG. 3A and the HDL code associated with the truth table and/or KMap as depicted in FIG. 3B. 354 illustrates the HDL code obtained at 352 being simulated with a template test bench to generate an output waveform file. 356 provides printed waveforms in text format, which can be used to construct a waveform problem. The synthetic data associated with the waveform problems can be used as training data for fine-tuning a pretrained LLM to correctly process non-textual inputs.

FIG. 1B illustrates a flowchart of a process 150 for using targeted code repair to generate synthetic training data to improve HDL code generation, in accordance with an embodiment. Each block of process 150, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, process 150 is described, by way of example, with respect to the system of FIG. 2. However, this method may additionally or alternatively be executed by any one system, or any combination of systems, including, but not limited to, those described herein. Furthermore, persons of ordinary skill in the art will understand that any system that performs process 150 is within the scope and spirit of embodiments of the present disclosure.

At 152, process 150 samples a number of code portions generated by an HDL code-generating large language model (LLM). For example, an LLM can be provided a prompt to generate a portion of HDL code. Inat least one embodiment, the prompt provided to the LLM is non-textual in nature—or includes elements that are non-textual in nature, e.g., a KMap or a state diagram for an FSM.

At 154, process 150 uses verifiable test benchmarks to detect and correct errors in sampled completed code. For example, an evaluator LLM is configured to use the verifiable test benchmarks to detect errors within the sampled completed code, which is generated by the HDL code-generating LLM. In such cases, the evaluator LLM also corrects minor errors occurring in HDL code that is generated using the HDL code-generating LLM. In some embodiments, the HDL code-generating LLM can generate HDL code based on prompts provided to the HDL code-generating LLM. The code generated by the HDL code-generating LLM can include minor errors, which are small, detailed, and seemingly trivial. For example, the HDL source code generated by the HDL code-generating LLM can by tested using a plurality of benchmark tests that test the accuracy and reliability of the generated HDL source code. In such cases, the plurality of benchmark tests includes automatically verifiable test benches to reveal minor errors that are included in the generated HDL source code. The evaluator LLM can also be configured to correct the errors detected in the generated HDL source code. The evaluator LLM also determines whether the correction to the generated HDL is corrected by testing the revised generated HDL source code against the automatically verifiable testbenches again. In case the corrected code passes the tests of the automatically verifiable testbenches, the corrections are considered to be accurate. Otherwise, the evaluator LLM can deem the corrections inaccurate and provide further corrections to the generated HDL source code. In some embodiments, a user reviewing the generated HDL code is also able to correct the minor error occurring in the generated HDL code.

At 156, process 150 generates a detailed error report based on the correction performed in the generated HDL code. In some embodiments, the process 150 generates the detailed error report of the generated HDL code provided by the code generation LLM using the evaluator LLM. For example, the process 150 provides a prompt to the evaluator LLM that includes the erroneous HDL code generated by the HDL code generation LLM, the corrected HDL code generated by the evaluator LLM and the prompt that was provided to the HDL code-generating LLM to generate the erroneous HDL code. The prompt can also include instructions to examine the nature of the error occurring in the erroneous code by comparing the erroneous HDL code with the corrected HDL code. In some embodiments, the evaluator LLM is also tasked with categorizing the error into a functional type (e.g., logic, multiplexing, and arithmetic operations). Additionally, when reviewing multiple such errors occurring in the same or different segments of generated HDL code, the evaluator LLM is also prompted to identify mistakes in common error patterns, for example, frequent mistakes in arithmetic shifts, bit manipulation, and unintended latch creation. Based on performing the analysis, the evaluator LLM generates a detailed error report that not only categorizes the errors but also highlights areas where the HDL code-generating LLM consistently underperforms. In some embodiments, the evaluator LLM can be based on a nemotron-340b-instruct model.

At 158, the process 150 determines whether the generated detailed error report is self-consistent. In some embodiments, in order to determine that the generated detailed error report is self-consistent, a two-phase validation process is implemented in the HDL code-generating LLM. In a first phase, a self-consistence check of the generated detailed error report is conducted by having the HDL code-generating LLM fix the erroneous HDL code based on the information provided in the generated detailed error report. In case the HDL code-generating LLM is unable to fix the erroneous HDL code based on the detailed error report, the detailed error report is considered to not be self-consistent. In some embodiments, the evaluator LLM can compare the fixed erroneous HDL code against the corrected HDL code generated at 154 to determine whether the HDL code-generating LLM was able to correctly fix the erroneous HDL code based on the generated detailed error report. This verifies the accuracy of the generated detailed report by confirming that the HDL code-generating LLM can resolve the errors in the generated HDL using the provided guidance. In some additional embodiments, in the second phase of the two-phase validation process, performed later in the process 150, on the synthetic data generated by the process 150. In some cases, the synthetic data generated by the process 150 includes error-injected open-source code.

In case the LLM determines that the fixed erroneous HDL code is not the same as the corrected HDL code, the HDL code-generating LLM determines that the generated detailed error report is not self-consistent and the process 150 moves to 160 where the HDL code-generating LLM revises the detailed error report. Once the generated detailed error report is revised, the process 150 moves back to 156 where the now revised detailed error report is checked for being self-consistent.

In case the HDL evaluator LLM determines that the fixed HDL code is same as the corrected HDL code, the HDL code-generating LLM determines that the generated detailed error report is self-consistent, and the process 150 moves to 162, where the process 150 injects the previously detected minor errors in open-source HDL code. In some embodiments, the injection of the minor error in open-source HDL code is used to develop a targeted code repair dataset. For example, the minor error that is documented in the generated detailed test report, is injected in a portion of publicly available open-source HDL code to generate repair problems based on the minor errors that were corrected at 154.

At 164, the process 150 generates synthetic training data based on the minor error occurring in the generated HDL code at 152. In some embodiments, the synthetic training data that is generated also includes, in addition to the portion of the open-source code HDL code that is injected with the minor error, a repair problem. The repair problem includes a problem description, erroneous code implementation, and hints about the nature of the error and how to fix it. This strategy of generating synthetic data using targeted code repair enables the HDL code-generating LLM to learn to avoid common errors and improve code completions, thereby enhancing model accuracy.

At 166, the process 150 performs a self-verification on the generated synthetic data. For example, the generated synthetic data is provided as input to the evaluator LLM along with a prompt for the evaluator LLM to determine whether the error-injected portion of open-source HDL code, that is included as part of the synthetic generated data, is solved by the hints provided in the synthetic training data generated at 164. In case the evaluator LLM determines that the hints and the nature of the error information, as provided in the generated synthetic data at 164, solves the error in the generated HDL code, the evaluator LLM responds with “Yes,” or else the evaluator LLM responds with “No.” If the evaluator LLM determines that the corrected HDL code does not solve the error in the generated HDL code, the corrected HDL code is removed from the generated synthetic data. In some cases, the evaluator LLM can be prompted to revise the corrections to the generated HDL code. Additionally, and/or alternatively the evaluator LLM also performs deduplication, syntax filtering, and benchmark decontamination on the generated synthetic data. The synthetic data generated by process 150 be used for fine-tuning a pretrained HDL code-generating LLM to improve the quality, accuracy, and reliability of HDL source code.

In some embodiments, deduplication is performed using a pipeline that calculates MinHashes of all files, and maps similar files to similar buckets. In some alternate embodiments, decontamination is performed by removing files that contained docstrings or solutions from VerilogEval and RTLLM coding benchmarks. In some alternate embodiment, syntax filtering is performed by conducting syntax checks of the code using HDL simulators (which also have compile capability). Code entries where HDL simulator fails to compile the code are removed and corresponding syntax errors are reported.

FIG. 3D illustrates targeted code repair training data chart 375 for improving HDL code generation, in accordance with an embodiment. The synthetic training data 376 in FIG. 3D is generated based on a minor error detected in HDL code generated at 152 of FIG. 1B, using the HDL code-generating LLM. The minor error detected in the generated HDL code is corrected using verifiable test benchmarks. Once the minor error detected in the generated HDL code is corrected, the minor error is injected in publicly available open-source HDL code to generate synthetic training data 376. In accordance with at least one embodiment, the generated synthetic training data 376 includes a problem description 378, an erroneous implementation of a portion of publicly available HDL code 380, hints for fixing the error in the erroneous implementation of open-source code 382 and the corrected portion of publicly available HDL code 384.

FIG. 1C illustrates a flowchart of a process 175 for using synthetic training data to fine-tune a pretrained LLM to provide improved HDL code generation capabilities, in accordance with an embodiment. Each block of process 175, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, process 175 is described, by way of example, with respect to the system of FIG. 2. However, this method may additionally or alternatively be executed by any one system, or any combination of systems, including, but not limited to, those described herein. Furthermore, persons of ordinary skill in the art will understand that any system that performs process 175 is within the scope and spirit of embodiments of the present disclosure.

At 176, the process 175 obtains a pretrained LLM. In at least one embodiment, the pretrained LLM can be a HDL code-generating LLM, such as CodeLlama-7B-Instruct or Deepseek-Coder-6.7b-Instruct. At 178, the process 175 obtains synthetic training data. For example, the synthetic training data can be generated for non-textual representations such as KMaps, truth tables, FSMs, or waveform representations, as described with respect to FIGS. 1A and 1B. In at least one embodiment, the synthetic training data is provided as a problem-solution pair. For example, the problems can be generated using non-textual representations such as KMaps, truth tables, FSMs, or waveforms, and solutions to such problems can include HDL code associated with the non-textual representations. Additionally, and/or alternatively, the synthetic training data can include targeted code repair data that is generated based on minor errors detected in HDL code generated using an HDL code-generating LLM. In at least one embodiment, the synthetic code repair data includes a problem description, a portion of open-source HDL code that is injected with a minor error detected in the HDL code generated by the HDL code-generating LLM, hints on how to fix the minor error that injected in the portion of publicly available open-source HDL code, and a solution to the minor error injected to the portion of publicly available open-source HDL code.

At 180, the process 175 generates a prediction using the pretrained LLM. In at least one embodiment, the pretrained LLM selects a problem from the samples of problem-solution pairs present in the synthetic training data, and predicts a solution for the selected problem. At 182, the process 175 compares the prediction generated at 180 with a ground truth solution present in the synthetic training data. For example, in case the pretrained LLM generates HDL code for a non-textual representation, the generated code can be compared with actual, correct-by-construction code associated with the non-textual representation in the synthetic training data. At 184, the process 175 computes model loss of the pretrained LLM based on the comparison. In at least one embodiment, the model loss is calculated using a loss function defined for the pretrained LLM. At 186, the process 175 updates parameters of the pretrained LLM based on the computed model loss.

At 188, the process 175 determines whether the fine-tuning of the pretrained LLM is complete. In at least one embodiment, the determination of whether the fine tuning of the pretrained LLM is complete is based on a plurality of factors. For example, the pretrained LLM monitors for convergence, which is the point at which further training no longer yields significant improvements in the LLM's performance. If it is determined that the fine-tuning of the pretrained LLM is not complete, the process 175 moves to 180 to sample another problem from the synthetic training data. The steps 180-186 are repeated until the fine-tuning of the pretrained LLM is complete. Once it is determined that fine-tuning is complete, the process 175 ends at 190.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

FIG. 2 illustrates a block diagram of an example system suitable for use in implementing some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the system 200 is within the scope and spirit of embodiments of the present disclosure.

The system 200 includes a computation engine 204 that receives an input 202 and produces an output 212. The computation engine 204 includes an HDL coding LLM 206, an evaluator LLM 208, and a synthetic training data generator 210.

In some embodiments, the input 202 provided to the computation engine 204 can include a non-textual representation of data, such as KMaps, truth tables, or state diagrams for FSMs. In such cases, the computation engine 204 utilizes the synthetic training data generator 210 to create training data for non-textual representations such as truth tables, Karnaugh Maps (KMaps), and finite state machines (FSMs). The training data created by the synthetic training data generator 210 includes correct-by-construction code problems and solutions based on non-textual representations of truth tables, KMaps, and FSMs, as described in FIG. 1A. Additionally, and/or alternatively, the synthetic training data generator 210 can use the correct-by-construction code problems and solutions generated for truth tables, KMaps, and FSMs to produce waveform value change dump (VCD) files, which are then parsed and converted into wave form representations. The waveform representations are then used to generate training data for another non-textual representation of data, e.g., waveforms. The generated training data is provided as output 212 of the computation engine 204.

In some additional embodiments, the input 202 provided to the computation engine 204 can include a prompt to generate a portion of HDL code. Based on the prompt the HDL coding LLM 206 of the computation engine 204 can generate a portion of HDL code based on the prompt. The prompt provided as input 202 can be non-textual, such as a truth table, KMap, or a state diagram for an FSM. The portions of HDL code generated by the HDL coding 206 are sampled by an evaluator LLM 208. The evaluator LLM 208 is configured to use the verifiable test benchmarks to detect and correct errors within the sampled completed code, which is generated by the HDL coding LLM 206.

Based on errors detected and corrected in the generated portion of HDL code, the evaluator LLM 208 generates a detailed error report. For example, a second prompt is provided to the evaluator LLM 208 that includes the erroneous HDL code generated by the HDL coding LLM 206, the corrected HDL code generated by the evaluator LLM 208 and the prompt that was provided to the HDL coding LLM 206 to generate the erroneous HDL code. The prompt can also include instructions to examine the nature of the error occurring in the erroneous code by comparing the erroneous HDL code with the corrected HDL code. The error report once generated by the evaluator LLM 208, can be provided to the synthetic training data generator 210 of the computation engine 204 to generate synthetic training data to improve the quality, accuracy, and reliability of the HDL source code that is generated by the HDL coding LLM 208. The synthetic training data is provided as output 212 of the computation engine 204.

FIG. 3E is a table 390 comparing the HDL code generation performance of an LLM fine-tuned with synthetic training data, in accordance with an embodiment of the present disclosure, to that of alternative LLMs. As demonstrated by the code generation performance results provided in FIG. 3E, the HDL code generation performance is significantly improved through fine-tuning using synthetic training data as described above. In particular, the improved code generation performance is demonstrated by higher pass rates, for both syntax correctness and functional correctness, of LLMs fine-tuned using synthetic training data, in accordance with an embodiment of the present disclosure, in generating Register Transfer Level (RTL) code from natural language instructions. For example, Starcoder2, when fine-tuned with synthetic training data described above, generates HDL code with better functional correctness as compared to other code-generating LLMs not fine-tuned with the synthetic training data described above.

For example, LLMs trained with such synthetic training data outperforms conventional LLMs by 3.8%, 10.9%, 6.6% for pass@1 on VerilogEval-Machine, VerilogEval-Human, and RTLLM, respectively.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

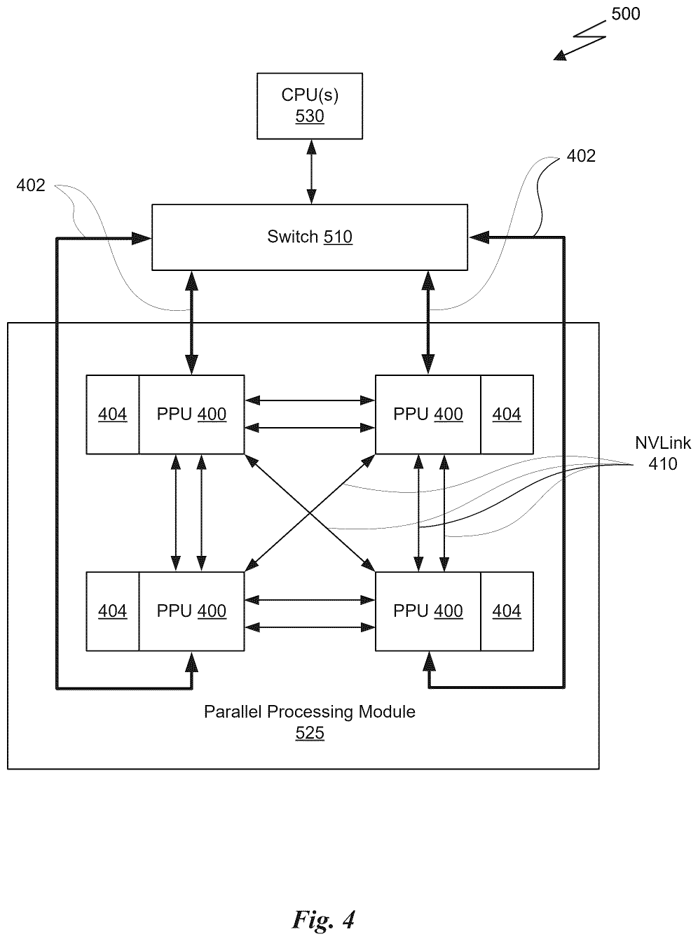

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

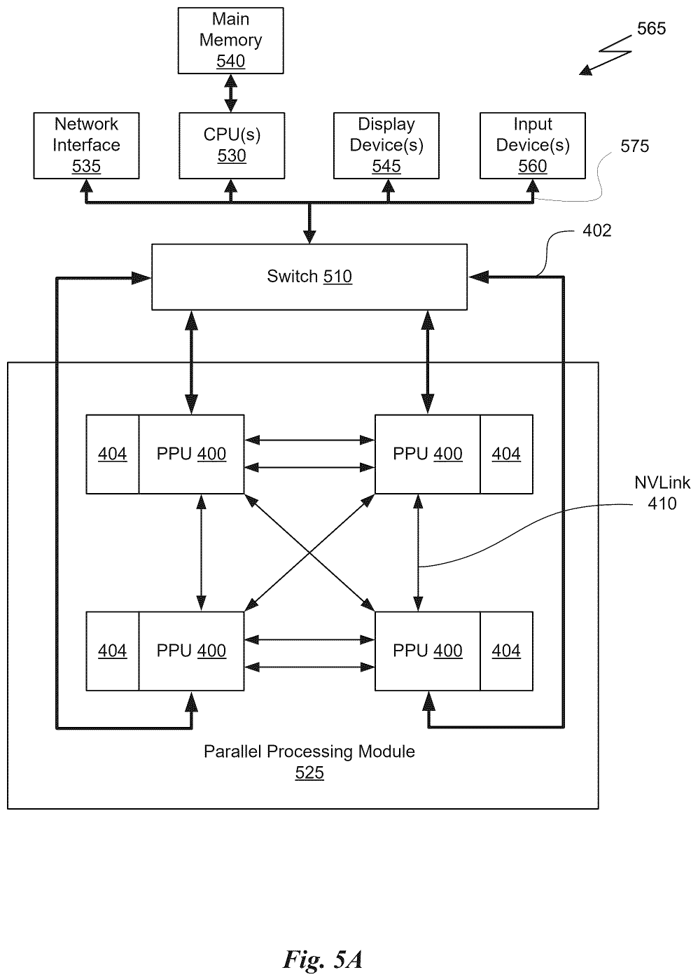

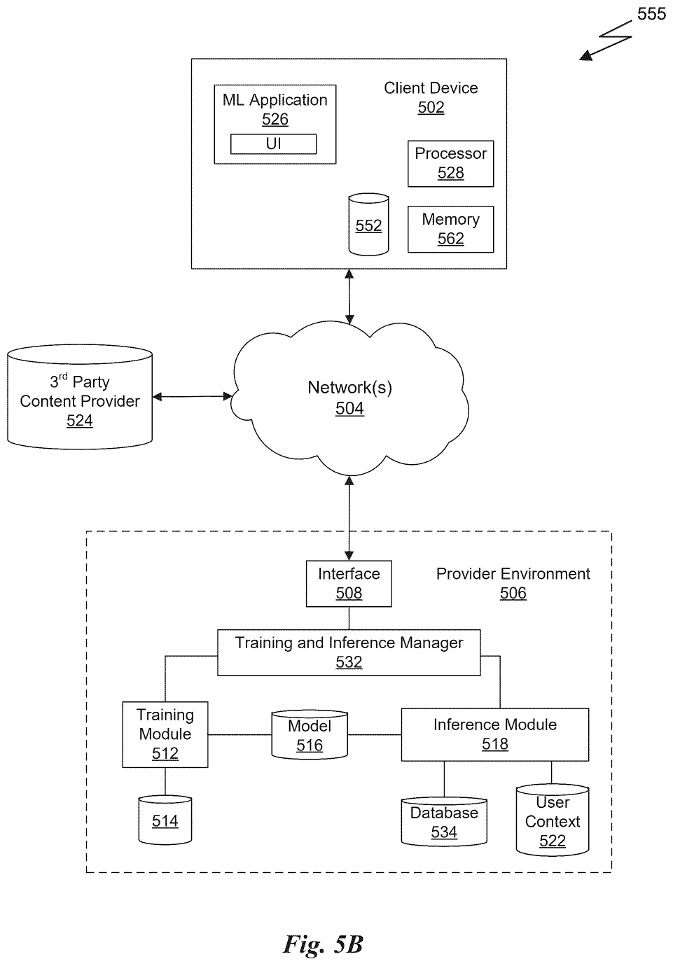

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third-party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third-party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used, or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third-party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or another model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

### Example Streaming System

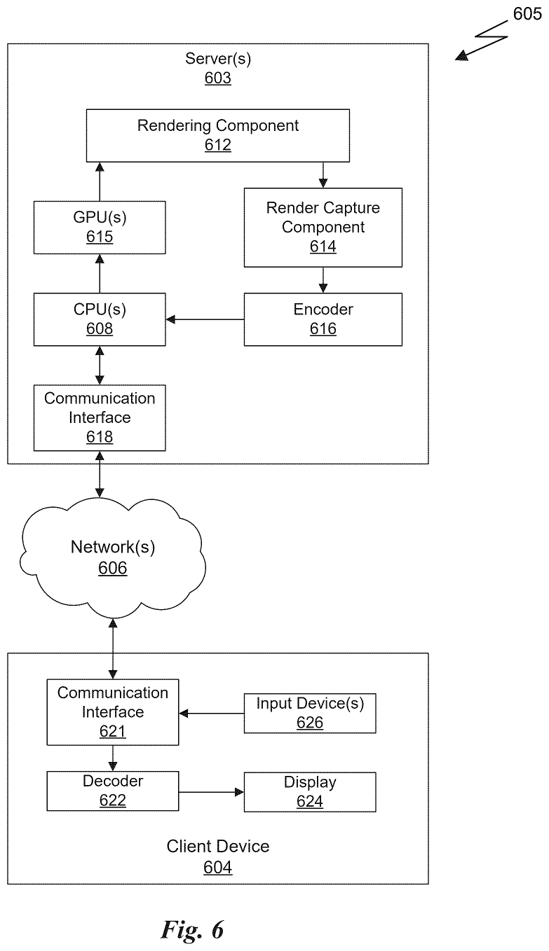

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering-in particular ray or path tracing - for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques-of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic formats. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component.

Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for fine-tuning a pretrained large language model (LLM) to provide a fine-tuned LLM for generating hardware description language (HDL) code, the method comprising:
obtaining the pretrained LLM;
obtaining a first training dataset, the first training dataset comprising correct-by-construction non-textual representation data samples; and
fine-tuning, using the first training dataset, the pretrained LLM to provide the fine-tuned LLM for generating HDL code.

2. The method of claim 1, wherein obtaining the first training dataset comprises:
sampling a plurality of random configurations associated with a non-textual representation of data;
generating a plurality of problems associated with the non-textual representation of data based on the sampled plurality of random configurations; and
generating hardware description language (HDL) source code for the non-textual representation of data by solving the plurality of problems of the non-textual representation of data.

3. The method of claim 2, wherein the non-textual representation is a truth table, and wherein sampling the plurality of random configurations comprises randomly selecting a number of input variables from a set of possible numbers of input variables for generating the truth table.

4. The method of claim 3, wherein generating the plurality of problems associated with the non-textual representation of data comprises generating minterms and don't-care terms based on the selected number of input variables.

5. The method of claim 4, wherein solving the plurality of problems of the non-textual representation of data comprises generating at least one of a truth table and a Karnaugh map associated with the plurality of problems.

6. The method of claim 2, wherein the non-textual representation is a finite state machine, and wherein sampling the plurality of random configurations comprises randomly selecting a number of states, an input bit width, and an output bit width.

7. The method of claim 6, wherein generating the plurality of problems comprises generating a legal state transition graph based on the selected number of states.

8. The method of claim 2, further comprising:
generating a plurality of testbenches associated with the HDL source code;
simulating the HDL source code along with the plurality of testbenches using an HDL simulator to generate an output file; and
constructing a waveform problem based on the output file.

9. The method of claim 1, wherein the method further comprises:
obtaining a second training dataset, the second training dataset comprising targeted code repair data samples; and
fine-tuning, using the second training dataset, the pretrained LLM to provide the fine-tuned LLM for generating HDL code.

10. The method of claim 9, wherein obtaining the second training dataset comprises correcting an error detected in a portion of hardware description language (HDL) source code generated by the LLM;
generating a detailed error report based on the correction performed in the portion of HDL code;
determining whether the generated detailed error report is consistent; and
injecting a portion of open-source HDL source code with the detected error based on determining that the generated detailed error report is consistent.

11. The method of claim 10, wherein determining whether the generated detailed error report is consistent comprises:
determining whether the generated detailed error report fixes the error detected in the portion of the HDL source code; and
determining that the generated detail report is self-consistent based on determining that the generated detailed error report fixes the error detected in the portion of the HDL source code.

12. The method of claim 10, further comprising:
performing a self-verification of the second training dataset, wherein performing the self-verification of the second training dataset comprises:
determining whether the second training dataset solves the error injected in the portion of open-source HDL source code.

13. The method of claim 12, wherein based on determining that the second training dataset does not solve the error injected in the portion of open-source HDL source code, discarding the second training dataset.

14. The method of claim 1, wherein fine-tuning, the pretrained LLM to provide the fine-tuned LLM for generating HDL code comprises:
selecting, using the pretrained LLM, a problem from the first training dataset;
predicting, using the pretrained LLM, a solution to the problem selected from the first training dataset;
comparing the predicted solution with an actual solution to the problem stored in the first training dataset;
determining a model loss associated with the fine-tuned LLM based on the comparing; and
updating parameters of the pretrained LLM based on the determined model loss.

15. The method of claim 14, further comprising:
determining whether the fine-tuning of the pretrained LLM is complete; and
based on determining that the fine-tuning of the pretrained LLM is not complete, repeating steps a)-e).

16. A system for fine-tuning a pretrained large language model (LLM) to provide a fine-tuned LLM for generating hardware description language (HDL) code, the system comprising:
processing circuitry configured to:
obtain the pretrained LLM;
obtain a first training dataset, the first training dataset comprising correct-by-construction non-textual representation data samples; and
fine-tune, using the first training dataset, the pretrained LLM to provide the fine-tuned LLM for generating HDL code.

17. The system of claim 16, wherein the processing circuitry configured to obtain the first training dataset, is further configured to:
sample a plurality of random configurations associated with a non-textual representation of data;
generate a plurality of problems of the non-textual representation of data based on the sampled plurality of random configurations; and
generate hardware description language (HDL) source code for the non-textual representation of data by solving the plurality of problems of the non-textual representation of data.

18. The system of claim 17, wherein the non-textual representation is a truth table, and wherein sampling the plurality of random configurations comprises randomly selecting a number of input variables from a set of possible number of input variables for generating the truth table.

19. The system of claim 18, wherein generating the plurality of problems associated with the non-textual representation of data comprises generating minterms and don't-care terms based on the selected number of input variables.

20. A non-transitory computer-readable medium having stored thereon instructions that, when executed by processing circuitry, cause the processing circuitry to fine-tune a pretrained large language model (LLM) to provide a fine-tuned LLM for generating hardware description language (HDL) code, the method comprising:
obtaining the pretrained LLM;
obtaining a first training dataset, the first training dataset comprising correct-by-construction non-textual representation data samples; and
fine-tuning, using the first training dataset and the second training dataset, the pretrained LLM to provide the fine-tuned LLM for generating HDL code.

21. The non-transitory computer-readable medium of claim 20, wherein obtaining the first training dataset comprises:
sampling a plurality of random configurations associated with a non-textual representation of data;
generating a plurality of problems associated with the non-textual representation of data based on the sampled plurality of random configurations; and
generating hardware description language (HDL) source code for the non-textual representation of data by solving the plurality of problems of the non-textual representation of data.

22. The non-transitory computer-readable medium of claim 20, wherein the method further comprises:
obtaining a second training dataset, the second training dataset comprising targeted code repair data samples; and
fine-tuning, using the second training dataset, the pretrained LLM to provide the fine-tuned LLM for generating HDL code.

23. The non-transitory computer-readable medium of claim 22, wherein obtaining the second training dataset comprises correcting an error detected in a portion of hardware description language (HDL) source code generated by the LLM;
generating a detailed error report based on the correction performed in the portion of HDL code;
determining whether the generated detailed error report is consistent; and
injecting a portion of open-source HDL source code with the detected error based on determining that the generated detailed error report is consistent.
